(19) United States
(12) Patent Application Publication
(10) Pub. No.: US 2009/0279687 A1
(43) Pub. Date: Nov. 12, 2009

(54) CRYPTOGRAPHIC OPERATION PROCESSING CIRCUIT

(76) Inventors: Tetsuro Yoshimoto, Osaka (JP); Takayuki Tanaka, Osaka (JP)

Correspondence Address: MCDERMOTT WILL & EMERY LLP, 600 13TH STREET, NW, WASHINGTON, DC, 20005-3096, US

(21) Appl. No.: 12/094,927

(22) PCT Filed: Jun. 19, 2007
(86) PCT No.: PCT/JP2007/062293

§ 371 Date: May 23, 2008

(30) Foreign Application Priority Data
Nov. 9, 2006 (JP) 2006-304068

(51) Int. Cl. H04L 9/10; H04L 9/28

(52) U.S. Cl. 380/28

(57) ABSTRACT

A dummy operation instruction circuit (100) is provided for issuing a dummy operation instruction (113) to a cryptographic control circuit (101) instead of a CPU (109) or the like after being notified of execution of a cryptographic operation instruction (111) from the CPU (109) or the like. By causing operation resources (103 to 108), such as a memory, an operator, a register and the like, after the execution of the cryptographic operation instruction (111), though they are normally inactivated for that period, so that a current is consumed, it is difficult to identify timing of the end, start and the like of a cryptographic operation process based on the magnitude of a consumed current. The dummy operation instruction (113) is issued only for a period of time for which the cryptographic operation instruction (111) is not issued from the CPU (109) or the like. Therefore, the performance of the cryptographic operation process is not deteriorated.

### TECHNICAL FIELD

The present invention relates to a cryptographic operation processing circuit, and more particularly, to a cryptographic operation processing circuit comprising a means for preventing analysis of secret data, such as an encryption key or the like.

### BACKGROUND ART

Recently, as electronic commerce, automatic ticket gates and the like that employ IC cards, mobile telephones with IC card functions or the like have been developed, it is important to secure the security of IC cards or the like.

However, methods have been found in which, by observing and analyzing power consumption (consumed current) when an IC card is performing a cryptographic operation process, an encryption key or details of the cryptographic operation process in the IC card are analyzed. Representative examples of such an analysis means include simple power analysis (SPA), in which variations in consumed current are directly used for analysis, differential power analysis (DPA), in which a secret encryption key is estimated by performing a statistical process with respect to observed data, and the like.

In order to address the conventional simple power analysis, there are known methods in which a dummy process for changing the timing of a cryptographic operation procedure is inserted in a normal process or a consumed current is changed on a time axis by changing an operation clock cycle. In these methods, the procedure or timing of a cryptographic operation process is changed every time it is performed, so that a consumed current waveform is changed as viewed on the time axis. Therefore, data-dependent analysis in which current waveforms are compared on the time axis is substantially disabled, thereby achieving security (see Patent Document 1).

In order to address the conventional differential power analysis, there is a known method in which a noise generating circuit superimposes a noise current onto a consumed current of a normal process. In this technique, even when the same operation is performed a plurality of times, resultant current waveforms differ from each other, thereby making it difficult to perform differential analysis to achieve security (see Patent Document 2).

### Patent Document 1: Japanese Unexamined Patent Application Publication No. 2000-259799

### Patent Document 2: Japanese Unexamined Patent Application Publication No. 2005-252705

### DISCLOSURE OF THE INVENTION

### Problems to be Solved by the Invention

If a dummy process for changing the timing of a cryptographic operation procedure is added to an excessively large extent so as to address simple power analysis, a time required to complete the execution of a cryptographic operation is caused to be long, so that the performance of a cryptographic operation process is significantly reduced. Conversely, if a dummy process for changing the timing of a cryptographic operation procedure is added to a small extent, a reduction in the performance of a cryptographic operation process is small. In this case, however, variations in current waveform of a normal cryptographic process are easily tapped from the outside.

In the case of the technique of changing a consumed current on a time axis by changing an operation clock cycle so as to address simple power analysis, information, such as a clock cycle or the like, is easily observed from the outside, and an observed current waveform can be analyzed and repaired into a current waveform having a constant clock cycle by a digital signal process.

In the case of the technique of superposing a noise current onto a consumed current of a normal process by a noise generating circuit so as to address differential power analysis, a physical position at which a current is consumed inside an LSI can be identified by a recent LSI analysis technique, such as liquid crystal analysis, light emission analysis or the like. With liquid crystal analysis, a change in current at a specific location can be observed as a change in transmittance of liquid crystal, so that current analysis can be performed.

### Solution to the Problems

To solve the above-described problem, a cryptographic operation processing circuit according to the present invention comprises a memory for storing data for a cryptographic operation, an operator for operating the cryptographic operation data, a register for temporarily storing input/output data of the operator, a cryptographic control circuit for receiving a cryptographic operation instruction and controlling the memory, the operator and the register so as to perform a cryptographic process with respect to the cryptographic operation data, and a dummy operation instruction circuit for receiving an operation completion signal indicating that execution of the cryptographic operation instruction has been ended, and issuing a dummy operation instruction for operating the memory, the operator and the register to the cryptographic control circuit.

### EFFECT OF THE INVENTION

In the cryptographic operation processing circuit of the present invention, the dummy operation instruction circuit issues a dummy operation instruction for operating a memory, an operator or a register after execution of a cryptographic operation instruction from a CPU or the like, though they are normally inactivated for that period, so that the memory, the operator or the register is operated as in the case of a cryptographic operation instruction and a current is consumed. Therefore, it is difficult to identify timing of the end, start and the like of a cryptographic operation process based on the magnitude of a consumed current, resulting in an improvement in security. The dummy operation instruction is issued only for a period of time for which the cryptographic operation instruction is not issued from the CPU or the like, i.e., the issuance of the cryptographic operation instruction from the CPU or the like is not delayed. Therefore, the performance of the cryptographic operation process is not deteriorated.

### BRIEF DESCRIPTION OF THE DRAWINGS

FIG. 1 is a block diagram showing an exemplary configuration of a cryptographic operation processing circuit according to the present invention.

FIG. 2 is a timing diagram showing an operation of the cryptographic operation processing circuit of FIG. 1.

FIG. 3 is a timing diagram showing an operation when a dummy operation instruction circuit is not provided in the cryptographic operation processing circuit of FIG. 1.

FIG. 4 is a block diagram showing a detailed exemplary configuration of a dummy operation instruction circuit of FIG. 1.

FIG. 5 is a diagram showing exemplary contents stored in a cryptographic operation instruction storing circuit of FIG. 4.

FIG. 6 is a block diagram showing a detailed exemplary configuration of a cryptographic control circuit of FIG. 1.

FIG. 7 is a timing diagram showing an operation of a cryptographic operation processing circuit comprising the cryptographic control circuit of FIG. 6.

FIG. 8 is another timing diagram showing the operation of the cryptographic operation processing circuit comprising the cryptographic control circuit of FIG. 6.

FIG. 9 is still another timing diagram showing the operation of the cryptographic operation processing circuit comprising the cryptographic control circuit of FIG. 6.

FIG. 10 is still another timing diagram showing the operation of the cryptographic operation processing circuit comprising the cryptographic control circuit of FIG. 6.

FIG. 11 is a diagram showing FIGS. 7 to 10 together.

FIG. 12 is a block diagram showing a detailed exemplary configuration of a dummy control circuit of FIG. 6.

FIG. 13 is a diagram showing exemplary contents stored in a normal control signal storing circuit of FIG. 12.

FIG. 14 is a block diagram showing a variation of the cryptographic operation processing circuit of FIG. 1.

FIG. 15 is a diagram showing exemplary contents stored in a cryptographic operation instruction storing circuit of FIG. 14.

FIG. 16 is a diagram showing exemplary contents stored in a normal control signal storing circuit of FIG. 14.

FIG. 17 is a block diagram showing a configuration of a cryptographic control circuit and an operation section according to a variation of FIG. 6.

FIG. 18 is a timing diagram showing an operation of a cryptographic operation processing circuit comprising the cryptographic control circuit and the operation section of FIG. 17.

FIG. 19 is a block diagram showing a configuration of an operation section according to a variation of FIG. 17.

FIG. 20 is a timing diagram showing an operation of a cryptographic operation processing circuit comprising the operation section of FIG. 19.

### DESCRIPTION OF THE REFERENCE CHARACTERS

100 dummy operation instruction circuit
101 cryptographic control circuit
102 operation section
103 memory A
104 memory B
105 operator
106 register A
107 register B
108 register C
109 CPU
110 clock
111 cryptographic operation instruction
112 cryptographic operation completion signal
113 dummy operation instruction
114 operation completion signal
115 memory A control signal
116 register A control signal
117 register B control signal
118 operator control signal
119 register C control signal
120 memory B control signal
121 memory A output data
122 register A output data
123 register B output data
124 operator output data
125 register C output data
400 cryptographic operation instruction storing circuit
401 dummy operation instruction generating circuit
402 cryptographic operation instruction history information
600 operation status notification circuit
601 normal control circuit
602 dummy control circuit
603 selector
604 normal control circuit memory A control signal
605 normal control circuit register A control signal
606 normal control circuit register B control signal
607 normal control circuit operator control signal
608 normal control circuit register C control signal
609 normal control circuit memory B control signal
610 dummy control circuit memory A control signal
611 dummy control circuit register A control signal
612 dummy control circuit register B control signal
613 dummy control circuit operator control signal
614 dummy control circuit register C control signal
615 dummy control circuit memory B control signal
616 operation status notification signal
800 normal control signal storing circuit
801 dummy control signal generating circuit
802 normal control signal history information
1000 bit value-0 count circuit
1001 bit value-0 count information
1300 preset circuit A
1301 preset circuit B
1302 preset circuit A control signal
1303 preset circuit B control signal
1304 preset circuit A output data
1305 preset circuit B output data
1306 pulse signal generating circuit
1500 delay circuit A
1501 delay circuit B
1502 delay circuit A output data
1503 delay circuit B output data

### BEST MODE FOR CARRYING OUT THE INVENTION

Hereinafter, a best mode for carrying out the present invention will be described with reference to the accompanying drawings. Note that the same or like parts are indicated by the same reference numerals and will not be repeatedly described.

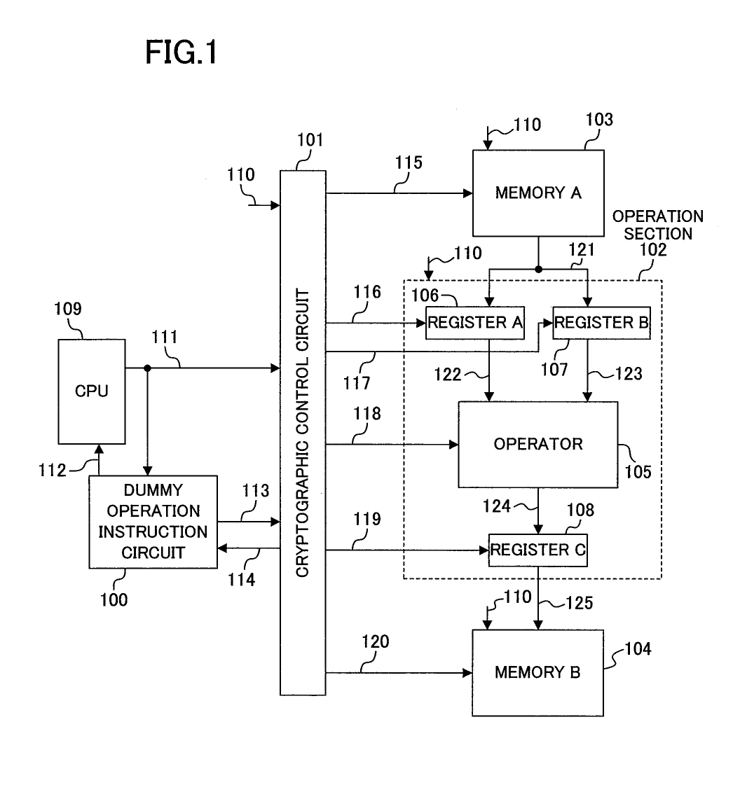

FIG. 1 shows an exemplary configuration of a cryptographic operation processing circuit according to the present invention. The cryptographic operation processing circuit of FIG. 1 comprises a dummy operation instruction circuit 100, a cryptographic control circuit 101, an operation section 102, a memory A 103, and a memory B 104. The operation section 102 comprises an operator 105, a register A 106, a register B 107, and a register C 108.

The dummy operation instruction circuit 100 recognizes that a cryptographic operation is started, based on a cryptographic operation instruction 111 output from a CPU 109, and thereafter, receives an operation completion signal 114 indicating that the execution of the cryptographic operation instruction 111 has been ended, and outputs a cryptographic operation completion signal 112 to the CPU 109 and issues a dummy operation instruction 113 to the cryptographic control circuit 101. Thereafter, the dummy operation instruction circuit 100, when receiving the operation completion signal 114 also indicating that the execution of the dummy operation instruction 113 has been ended and recognizing that a dummy operation has been completed, issues the dummy operation instruction 113 again. The issuance of the dummy operation instruction 113 is repeated until the cryptographic operation instruction 111 is newly issued from the CPU 109.

The cryptographic control circuit 101 receives the cryptographic operation instruction 111 from the CPU 109 or the dummy operation instruction 113 from the dummy operation instruction circuit 100, and outputs a memory A control signal 115, a memory B control signal 120, an operator control signal 118, a register A control signal 116, a register B control signal 117, and a register C control signal 119 so as to control the memory A 103, the memory B 104, the operator 105, the register A 106, the register B 107, and the register C 108. Also, the cryptographic control circuit 101, when the execution of the cryptographic operation instruction 111 or the dummy operation instruction 113 has been ended, outputs the operation completion signal 114. When the cryptographic operation instruction 111 is issued from the CPU 109 during the execution of a process of the dummy operation instruction 113, a control by the dummy operation instruction 113 is forcedly ended, and a process of the cryptographic operation instruction 111 is started.

The memory A 103 is, for example, a memory that is in synchronization with a falling edge of a clock 110 and outputs memory A output data 121 from an address indicated by the memory A control signal 115 from the cryptographic control circuit 101.

The memory B 104 is, for example, a memory that is in synchronization with a falling edge of the clock 110 and writes register C output data 125 to an address indicated by the memory B control signal 120 from the cryptographic control circuit 101.

The operator 105 is a combinational circuit that receives register A output data 122 and register B output data 123, performs an operation in accordance with the operator control signal 118, and outputs the result to operator output data 124.

The register A 106 receives the memory A output data 121, and when the register A control signal 116 from the cryptographic control circuit 101 is effective, holds and outputs the memory A output data 121 to the register A output data 122.

The register B 107 receives the memory A output data 121, and when the register B control signal 117 from the cryptographic control circuit 101 is effective, holds and outputs the memory A output data 121 to the register B output data 123.

The register C 108 receives the operator output data 124, and when the register C control signal 119 from the cryptographic control circuit 101 is effective, holds and outputs the operator output data 124 to the register C output data 125.

The CPU 109 issues the cryptographic operation instruction 111 to the cryptographic control circuit 101 to cause the cryptographic control circuit 101 to perform a cryptographic operation process, and also receives the cryptographic operation completion signal 112 from the dummy operation instruction circuit 100 to recognize the end of a cryptographic operation process.

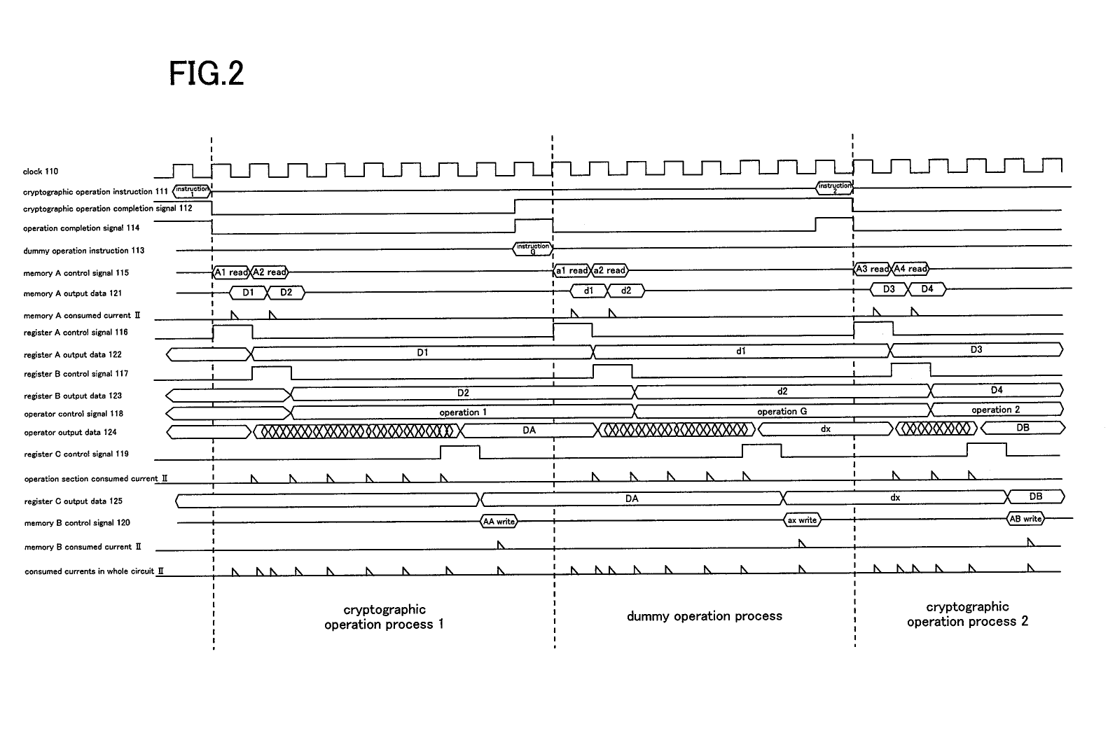

FIG. 2 shows an operation of the cryptographic operation processing circuit of FIG. 1. Here, as an example, it is assumed that the cryptographic operation instruction 111 called instruction 1 is initially issued from the CPU 109.

The cryptographic control circuit 101 decodes instruction 1 to read data D1 and data D2 from address A1 and address A2 of the memory A 103, and inputs data D1 to the register A 106 and data D2 to the register B 107. A memory A consumed current II is a consumed current caused by the memory A 103 performing a read operation and has a consumed current waveform corresponding to a read operation of address A1 and address A2.

The cryptographic control circuit 101 decodes instruction 1 to output operation 1 as the operator control signal 118. In this example, operation 1 is assumed to be an instruction that requires at least five clock cycles until an output result is settled. The operator 105 operates output D1 of the register A output data 122 and output D2 of the register B output data 123, and after three clock cycles, outputs DA as the operator output data 124. An operation section consumed current II is changed every time data is input to the register A 106 and the register B 107 that are input registers for the operator 105 that is a combinational circuit, and is consumed for three clock cycles even after values of the register A 106 and the register B 107 are settled, since an operation is executed for that period of time.

The cryptographic control circuit 101 decodes instruction 1 and outputs the register C control signal 119 for inputting an operation result to the register C 108 with timing when operation 1 is ended, so that DA is stored to the register C 108. Thereafter, the cryptographic control circuit 101 decodes instruction 1 and issues the memory B control signal 120, so that DA that is the register C output data 125 is stored into address AA of the memory B 104. A memory B consumed current II is a consumed current caused by a write operation to the memory B 104, and has a consumed current waveform corresponding to a write operation to address AA.

Thereafter, the cryptographic control circuit 101 outputs the operation completion signal 114 indicating the end of the execution of instruction 1 from the CPU 109, to the dummy operation instruction circuit 100.

The dummy operation instruction circuit 100 recognizes that a cryptographic operation for instruction 1 has been started, based on the cryptographic operation instruction 111 output from the CPU 109, and thereafter, receives the operation completion signal 114 that is a signal indicating the end of instruction 1, and outputs the cryptographic operation completion signal 112 to the CPU 109. A period of time from the start to the end of the cryptographic operation of instruction 1 is hereinafter defined as a “cryptographic operation process 1” period.

In the CPU 109, several tens of clock cycles are required as a program processing period so as to issue instruction 2 that is a new cryptographic operation instruction 111 after receiving the cryptographic operation completion signal 112. Note that, in FIG. 2, an example is shown in which instruction 2 is issued eight clocks after reception of the cryptographic operation completion signal 112 with respect to instruction 1.

The dummy operation instruction circuit 100 issues instruction G as the dummy operation instruction 113 to the cryptographic control circuit 101. It is here assumed that instruction G is an instruction that is fixedly output from the dummy operation instruction circuit 100, and with which data d1 and data d2 are read out from address a1 and address a2 of the memory A 103, respectively, data d1 and data d2 are stored into the register A 106 and the register B 107, respectively, a required operation is performed in the operator 105 for two clock cycles until an output result is settled, dx is stored as an operation result into the register C 108, dx is stored at address ax of the memory B 104, and thereafter, the operation completion signal 114 is output to the dummy operation instruction circuit 100, and a process of instruction G is thus completed. Note that address ax at which data is stored by the memory B control signal 120 needs not to destroy a memory space that is used by the cryptographic operation instruction 111 or the like, and therefore, an address that is not used by the CPU 109 is used as an address for storing data.

In accordance with the operation completion signal 114 indicating that the execution of the dummy operation instruction 113 has been ended, the dummy operation instruction circuit 100 repeatedly issues the dummy operation instruction 113 until the cryptographic operation instruction 111 is newly issued from the CPU 109. In the example of FIG. 2, however, instruction 2 that is a new cryptographic operation instruction 111 is issued from the CPU 109 with the same timing, so that the issuance of the dummy operation instruction 113 is interrupted. A period of time from the start to the end of execution of the dummy operation instruction 113 is hereinafter defined as a “dummy operation process” period.

In FIG. 2, a consumed current waveform of the whole cryptographic operation processing circuit of FIG. 1 is an addition of the memory A consumed current II, the operation section consumed current II, and the memory B consumed current II, i.e., a consumed current waveform obtained by summing “consumed currents II in whole circuit”. In FIG. 2, the consumed currents II in whole circuit have substantially a continuous consumed current waveform over the “cryptographic operation process 1” period and the “dummy operation process” period.

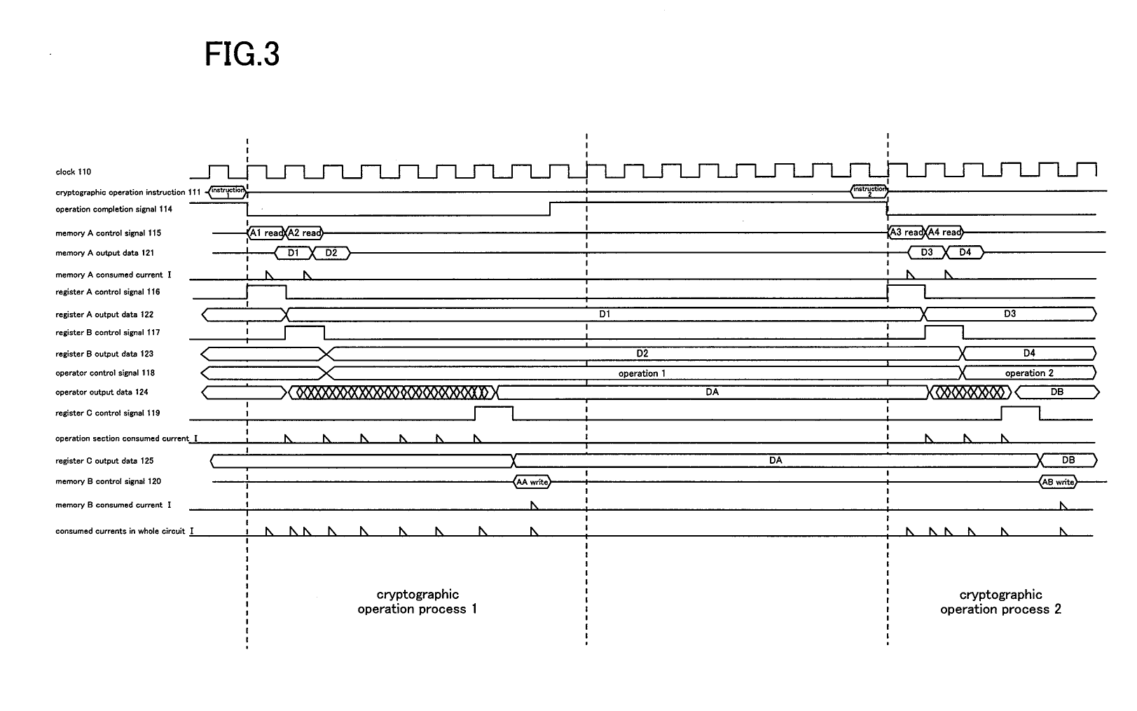

FIG. 3 shows an operation when the dummy operation instruction circuit 100 that is a component of the present invention is not provided in the cryptographic operation processing circuit of FIG. 1. In FIG. 3, the cryptographic operation processing circuit is not operated for a clock cycle period that corresponds to the “dummy operation process” period of FIG. 2, and therefore, that period is a period for which the consumed currents II in whole circuit have a continuous LOW-level waveform, so that the timing of the end and start of execution of an instruction can be revealed based on a change in consumed current waveform.

As described above, in the cryptographic operation processing circuit of FIG. 1, the dummy operation instruction circuit 100 issues the dummy operation instruction 113 for operating the memory A 103, the memory B 104, the operator 105, the register A 106, the register B 107, or the register C 108, which are normally inactivated, after the end of execution of the cryptographic operation instruction 111 from the CPU 109 or the like, so that the memory A 103, the memory B 104, the operator 105, the register A 106, the register B 107, or the register C 108 is operated and consumes a current as in the case where the cryptographic operation instruction 111 is issued. Therefore, it is difficult to identify the timing of the end, the start and the like of a cryptographic operation process based on the magnitude or the like of a consumed current, resulting in an improvement in security.

Further, the dummy operation instruction 113 is issued only for a period of time for which the cryptographic operation instruction 111 from the CPU 109 or the like is not issued. Thus, since the issuance of the cryptographic operation instruction 111 from the CPU 109 or the like is not delayed, the performance of the cryptographic operation process is not deteriorated.

Although it has been assumed above that the dummy operation instruction 113 is fixed and invariably the same, the same instruction as the cryptographic operation instruction 111 immediately previously issued from the CPU 109 may be issued as the dummy operation instruction 113. Thereby, even when the execution of the cryptographic operation instruction 111 is ended, the dummy operation instruction 113 having the same consumed current waveform is executed, so that it is difficult to analyze the timing of the end of execution of the cryptographic operation instruction 111, resulting in a further improvement in security against current analysis.

Note that the memory A 103 and the memory B 104 may be the same memory. Further, the operator 105 may have three or more inputs, and three or more registers for holding the input data may be provided. Further, the operator 105 may be comprised of a plurality of operational elements, such as an adder, a multiplier, and the like.

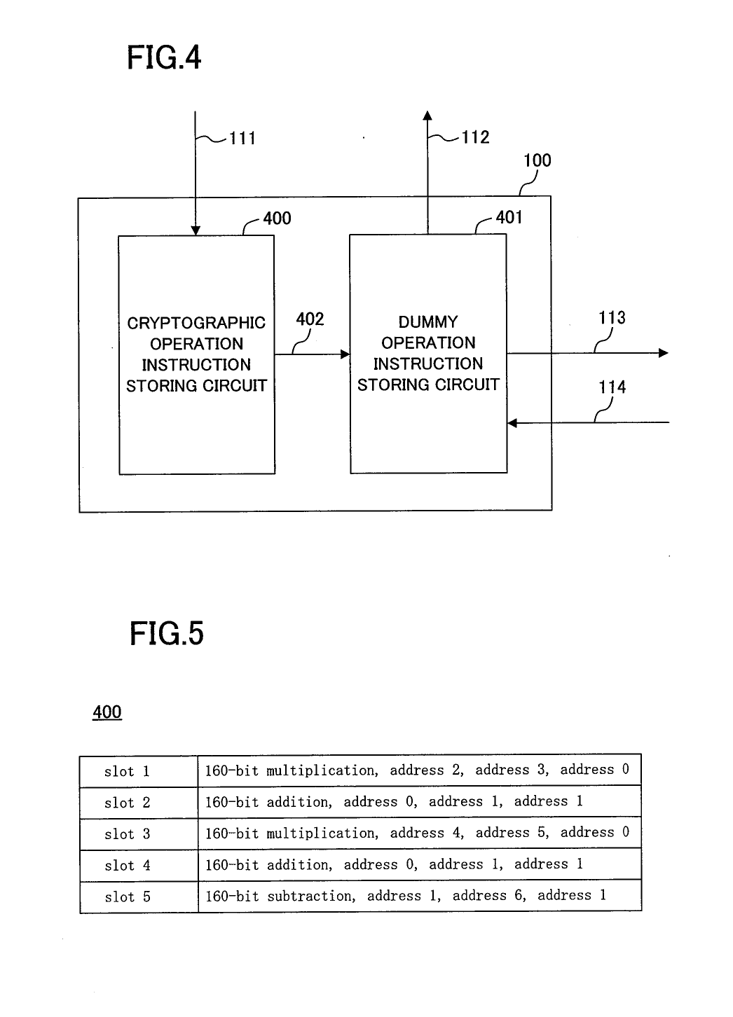

FIG. 4 shows a detailed exemplary configuration of the dummy operation instruction circuit 100 of FIG. 1. The dummy operation instruction circuit 100 of FIG. 4 comprises a cryptographic operation instruction storing circuit 400 for storing the cryptographic operation instruction 111 from the CPU 109, and a dummy operation instruction generating circuit 401 for generating the dummy operation instruction 113 from a past cryptographic operation instruction history.

The cryptographic operation instruction storing circuit 400 stores the cryptographic operation instruction 111 output by the CPU 109 as cryptographic operation instruction history information 402.

The dummy operation instruction generating circuit 401 receives the operation completion signal 114 that is a signal indicating the end of execution of the cryptographic operation instruction 111, and generates the dummy operation instruction 113 based on the cryptographic operation instruction history information 402 output from the cryptographic operation instruction storing circuit 400.

FIG. 5 shows exemplary contents stored in the cryptographic operation instruction storing circuit 400 of FIG. 4. As shown in FIG. 5, the cryptographic operation instruction storing circuit 400 stores a plurality of cryptographic operation instructions 111 issued in the past, in a FIFO (FIRST-IN FIRST-OUT) including a RAM. A FIFO address at which a cryptographic operation instruction 111 is stored is hereinafter referred to as a slot.

In FIG. 5, five slots are provided. Past cryptographic operation instructions 111 are stored into the slots, starting from slot 1. When the slots are full, a cryptographic operation instructions 111 are discarded from slot 5. Here, in slot 1, an instruction for multiplication where data of 160 bits in length is input from each of address 2 and address 3 and the result is output to address 0, is stored. In slot 2, an instruction for addition where data of 160 bits in length is input from each of address 0 and address 1 and the result is output to address 1, is stored. In slot 3, an instruction for multiplication where data of 160 bits in length is input from each of address 4 and address 5 and the result is output to address 0, is stored. In slot 4, an instruction for addition where data of 160 bits in length is input from each of address 0 and address 1 and the result is output to address 1, is stored. In slot 5, an instruction for subtraction where data of 160 bits in length is input from each of address 1 and address 6 and the result is output to address 1, is stored.

The dummy operation instruction generating circuit 401 receives the operation completion signal 114 that is a signal indicating that the execution of the cryptographic operation instruction 111 has been ended, and scans the cryptographic operation instructions 111 stored in slot 1 to slot 5 to recognize that there are two multiplications where 160 bits are input, two additions where 160 bits are input, and one subtraction where 160 bits are input. The multiplications and the additions have the same frequency of occurrence (the number of times). In slot 1 that has been issued at the latest, a multiplication is stored. Therefore, an addition is selected, i.e., slot 4 is selected, so that based on the cryptographic operation instruction 111 of slot 4, the dummy operation instruction 113 is generated in which an addition where data of 160 bits in length is input from each of address 0 and address 1 and the result is output to address AX, is performed. Address AX for storing data needs not to destroy a memory space that is used by the cryptographic operation instruction 111 or the like, and therefore, an address that is not used by the CPU 109 is used as the data storing address.

As described above, in the configuration of FIG. 4, cryptographic operation instructions 111 successively issued from the CPU 109 are stored into a RAM or the like, and from the stored cryptographic operation instructions 111, a cryptographic operation instruction 111 having a high frequency of occurrence is selected and issued as the dummy operation instruction 113. Therefore, even when current analysis is performed, it is difficult to distinguish the execution of successively issued cryptographic operation instructions 111 from the execution of a cryptographic operation instruction 111 having a high frequency of occurrence as the dummy operation instruction 113, resulting in a further improvement in security against current analysis.

Note that the dummy operation instruction generating circuit 401 may randomly select a cryptographic operation instruction 111 from the stored cryptographic operation instructions 111 and issue it as the dummy operation instruction 113. Thereby, even when current analysis is performed, it is difficult to distinguish the execution of successively issued cryptographic operation instructions 111 from the execution of a past cryptographic operation instructions 111 randomly selected as the dummy operation instruction 113, resulting in a further improvement in security against current analysis.

Also, the cryptographic operation instruction storing circuit 400 may be comprised of a non-volatile memory. Thereby, cryptographic operation instructions 111 successively issued from the CPU 109 or the like are stored in the non-volatile memory. Therefore, a history of past cryptographic operation instructions 111 can be stored after power-off, and a cryptographic operation instruction 111 is selected from the stored cryptographic operation instructions 111 and is issued as the dummy operation instruction 113. Therefore, even in the case of a current analysis technique in which, for example, a sequence of power-on, execution of a cryptographic operation, and power-off is repeatedly execute to observe changes in current waveform, it is difficult to distinguish the execution of a cryptographic operation instruction 111 from the execution of a past cryptographic operation instruction 111 as the dummy operation instruction 113, resulting in a further improvement in security against current analysis.

Although it has been assumed above that the number of slots in the cryptographic operation instruction storing circuit 400 is five, the number of slots may be increased or decreased.

A period of time for which the memories 103 and 104, the operator 105, and the registers 106, 107 and 108 are inactivated exists in some clock cycle units even when a cryptographic operation instruction 111 from the CPU 109 or the like is being executed. Also, even when the dummy operation instruction 113 is being executed, a period of time for which the memories 103 and 104, the operator 105, and the registers 106, 107 and 108 are inactivated exists in some clock cycle units. In view of this, in the following example, the operational resources 103 to 108 are invariably operated to consume a current, resulting in a further improvement in security against current analysis.

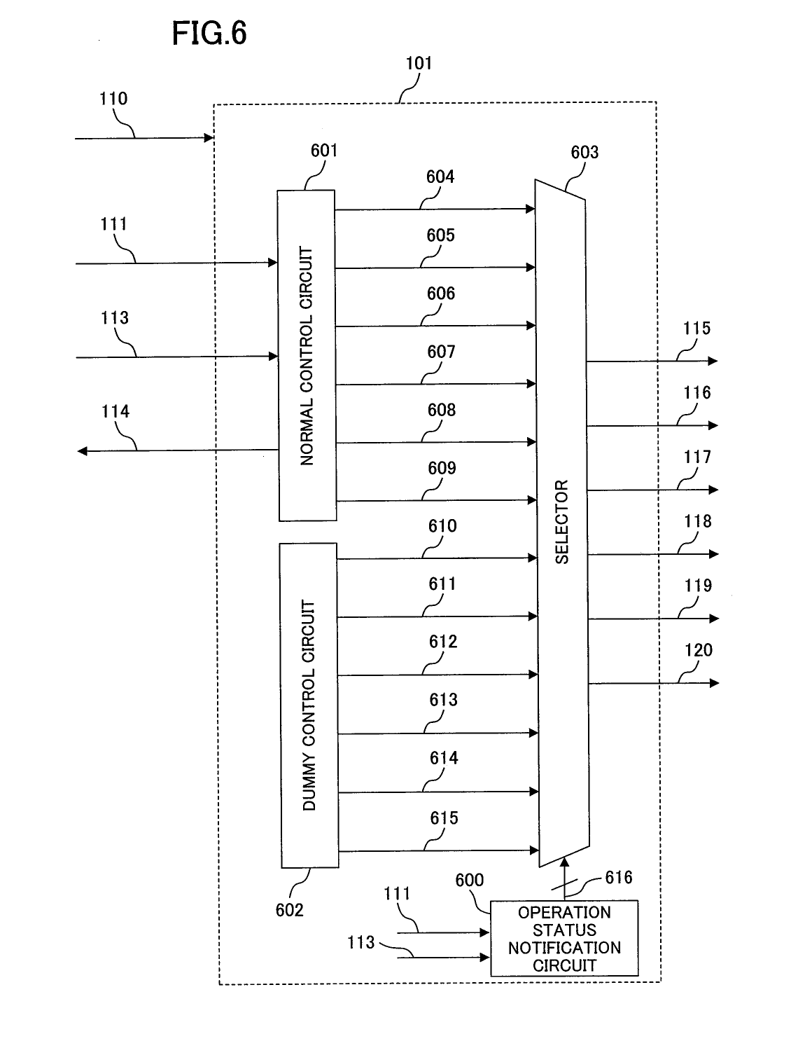

FIG. 6 shows a detailed exemplary configuration of the cryptographic control circuit 101 of FIG. 1. The cryptographic control circuit 101 of FIG. 6 comprises an operation status notification circuit 600, a normal control circuit 601, a dummy control circuit 602, and a selector 603.

The normal control circuit 601 receives the cryptographic operation instruction 111 or the dummy operation instruction 113, and outputs to the selector 603 a normal control circuit memory A control signal 604, a normal control circuit register A control signal 605, a normal control circuit register B control signal 606, a normal control circuit operator control signal 607, a normal control circuit register C control signal 608, and a normal control circuit memory B control signal 609 (these control signals are hereinafter referred to as normal control signals). Further, when a control by the cryptographic operation instruction 111 or the dummy operation instruction 113 has been ended, the normal control circuit 601 outputs the operation completion signal 114 to the dummy operation instruction circuit 100.

The dummy control circuit 602 outputs to the selector 603 a dummy control circuit memory A control signal 610, a dummy control circuit register A control signal 611, a dummy control circuit register B control signal 612, a dummy control circuit operator control signal 613, a dummy control circuit register C control signal 614, and a dummy control circuit memory B control signal 615 (these control signals are hereinafter referred to as dummy control signals).

The operation status notification circuit 600 outputs to the selector 603 a 6-bit operation status notification signal [5:0] 616 indicating a clock cycle period for which the normal control signal from the normal control circuit 601 does not need to occupy the memory A 103, the memory B 104, the operator 105, the register A 106, the register B 107, or the register C 108 even when the cryptographic operation instruction 111 or the dummy operation instruction 113 is being executed.

Based on the operation status notification signal [5:0] 616, the selector 603 selects the memory A control signal 115 from the normal control circuit memory A control signal 604 or the dummy control circuit memory A control signal 610 using an operation status notification signal [0], the register A control signal 116 from the normal control circuit register A control signal 605 or the dummy control circuit register A control signal 611 using an operation status notification signal [1], the register B control signal 117 from the normal control circuit register B control signal 606 or the dummy control circuit register B control signal 612 using an operation status notification signal [2], the operator control signal 118 from the normal control circuit operator control signal 607 or the dummy control circuit operator control signal 613 using an operation status notification signal [3], the register C control signal 119 from the normal control circuit register C control signal 608 or the dummy control circuit register C control signal 614 using an operation status notification signal [4], and the memory B control signal 120 from the normal control circuit memory B control signal 609 or the dummy control circuit memory B control signal 615 using an operation status notification signal [5].

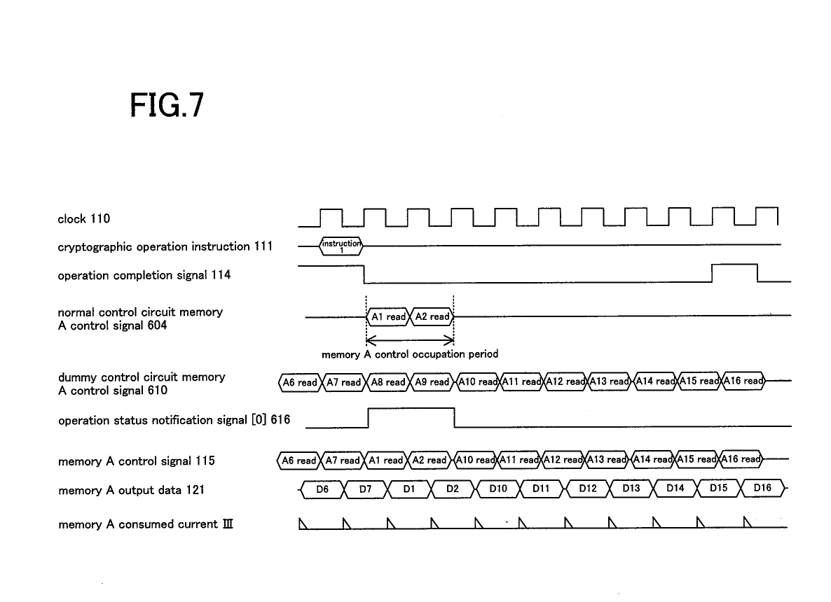

Next, an operation of the thus-configured cryptographic operation processing circuit will be described with reference to FIGS. 7 to 11. Note that, in FIGS. 7 to 10, periods of time for which the control signals from the cryptographic control circuit 101 occupy the memory A 103, the memory B 104, the operator 105, the register A 106, the register B 107, and the register C 108 so as to correctly execute the cryptographic operation instruction 111, are indicated as a “memory A control occupation period”, a “memory B control occupation period”, an “operator control occupation period”, a “register A control occupation period”, a “register B control occupation period”, and a “register C control occupation period”, respectively.

FIG. 7 shows an example in which the memory A control signal 115 is selected from the normal control circuit memory A control signal 604 or the dummy control circuit memory A control signal 610 based on the operation status notification signal [0] 616 from the operation status notification circuit 600.

The operation status notification signal [0] 616 is such that, as a result of decoding of the cryptographic operation instruction 111, the normal control circuit memory A control signal 604 is selected for two clock cycles, and the dummy control circuit memory A control signal 610 is selected for the other clock cycles. The normal control circuit memory A control signal 604 is a read signal for address A1 and address A2, and the dummy control circuit memory A control signal 610 outputs read signals for address A6 to address A16 that are incremented every clock.

The selector 603 outputs the memory A control signal 115 that accesses the memory A 103 every clock cycle from the normal control circuit memory A control signal 604 or the dummy control circuit memory A control signal 610 based on the operation status notification signal [0] 616. In accordance with the memory A control signal 115, the memory A output data 121 is read out from the memory A 103, and as a result, a consumed current waveform that consumes a current every clock cycle, such as a memory A consumed current III, is obtained.

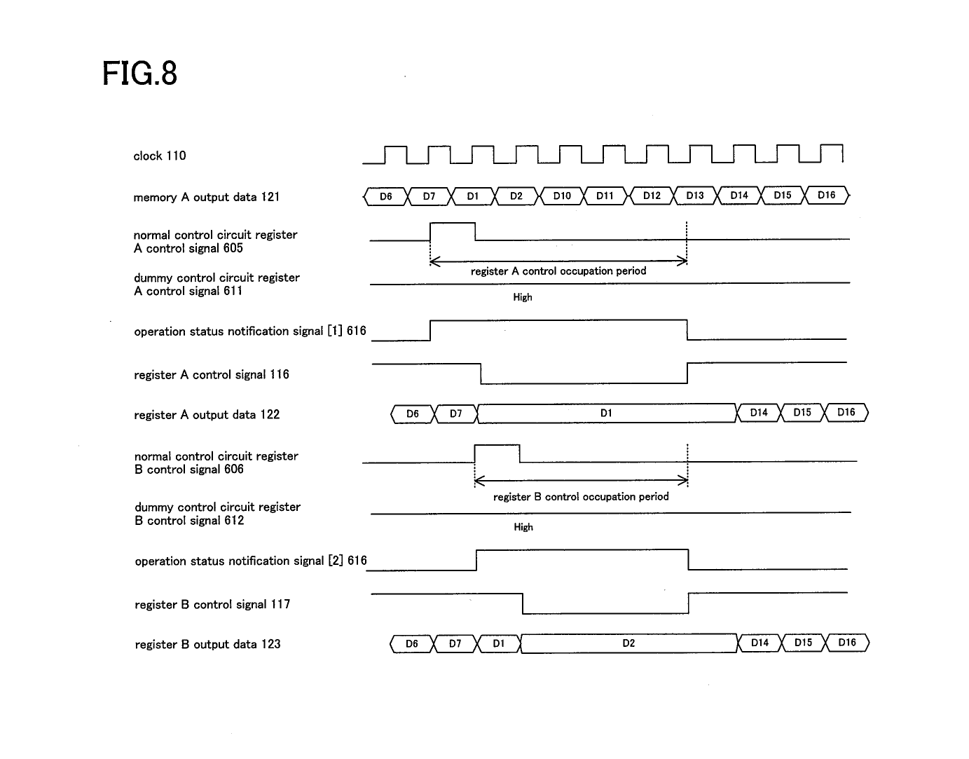

FIG. 8 shows an example in which, based on the operation status notification signal [1] 616 from the operation status notification circuit 600, the register A control signal 116 is selected from the normal control circuit register A control signal 605 or the dummy control circuit register A control signal 611, and based on the operation status notification signal [2] 616, the register B control signal 117 is selected from the normal control circuit register B control signal 606 or the dummy control circuit register B control signal 612.

The operation status notification signal [1] 616 is such that, as a result of decoding of the cryptographic operation instruction 111, the normal control circuit register A control signal 605 is selected for six clock cycles, and the dummy control circuit register A control signal 611 is selected for the other clock cycles. The normal control circuit register A control signal 605 is a signal for storing value D1 from the memory A output data 121 into the register A 106. The dummy control circuit register A control signal 611 outputs a signal that is invariably at a High level so as to input the memory A output data 121 to the register A 106 every clock cycle.

The operation status notification signal [2] 616 is such that, as a result of decoding of the cryptographic operation instruction 111, the normal control circuit register B control signal 606 is selected for five clock cycles, and the dummy control circuit register B control signal 612 is selected for the other clock cycles. The normal control circuit register B control signal 606 is a signal for storing value D2 from the memory A output data 121 into the register B 107. The dummy control circuit register B control signal 612 outputs a signal that is invariably at a High level so as to input the memory A output data 121 to the register B 107 every clock cycle.

Based on the operation status notification signal [1] 616, the selector 603 outputs the register A control signal 116 so that data D6, data D7, data D1, data D14, data D15, and data D16 from the memory A output data 121 are input to the register A 106. Also, based on the operation status notification signal [2] 616, the selector 603 outputs the register B control signal 117 so that data D6, data D7, data D1, data D2, data D14, data D15, data D16 from the memory A output data 121 are input to the register B 107.

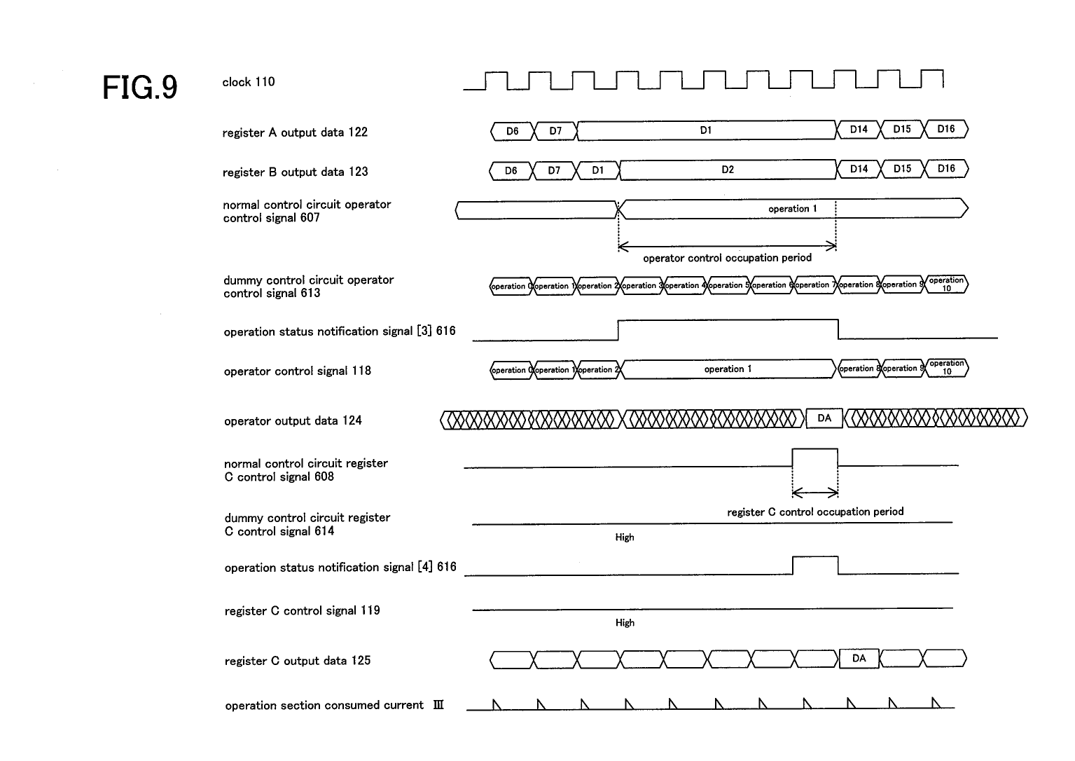

FIG. 9 shows an example in which, based on the operation status notification signal [3] 616 from the operation status notification circuit 600, the operator control signal 118 is selected from the normal control circuit operator control signal 607 or the dummy control circuit operator control signal 613, and based on the operation status notification signal [4] 616, the register C control signal 119 is selected from the normal control circuit register C control signal 608 or the dummy control circuit register C control signal 614.

The operation status notification signal [3] 616 is such that, as a result of decoding of the cryptographic operation instruction 111, the normal control circuit operator control signal 607 is selected for five clock cycles, and the dummy control circuit operator control signal 613 is selected for the other clock cycles. The normal control circuit operator control signal 607 is a signal for causing the operator 105 to execute operation 1 where value D1 from the register A output data 122 and value D2 from the register B output data 123 are input. The dummy control circuit operator control signal 613 is a signal for causing the operator 105 to operate where the register A output data 122 and the register B output data 123 are input. In this example, a signal for executing each of operation 0 to operation 10 in units of a clock cycle is output.

The operation status notification signal [4] 616 is such that, as a result of decoding of the cryptographic operation instruction 111, the normal control circuit register C control signal 608 is selected for one clock cycle, and the dummy control circuit register C control signal 614 is selected for the other clock cycles. The normal control circuit register C control signal 608 is a signal for storing value DA that is a result of an operation from the operator output data 124 into the register C 108. The dummy control circuit register C control signal 614 outputs a signal that is invariably at a High level so as to input the operator output data 124 to the register C 108 every clock cycle.

Based on the operation status notification signal [3] 616, the selector 603 outputs the operator control signal 118 for causing the operator 105 to execute operation 0, operation 1, operation 2, operation 1, operation 8, operation 9, and operation 10 where the memory A output data 122 and the memory B output data 123 are input to the operator 105. Also, based on the operation status notification signal [4] 616, the selector 603 outputs the register C control signal 119 for inputting the operator output data 124 to the register C 108 every clock cycle. By the operator control signal 118 and the register C control signal 119, an operation is executed in the operator 105 every clock cycle, and a result of the operation is stored into the register C 108, so that a consumed current waveform in which a current is consumed every clock cycle, such as an operation section consumed current III, is obtained.

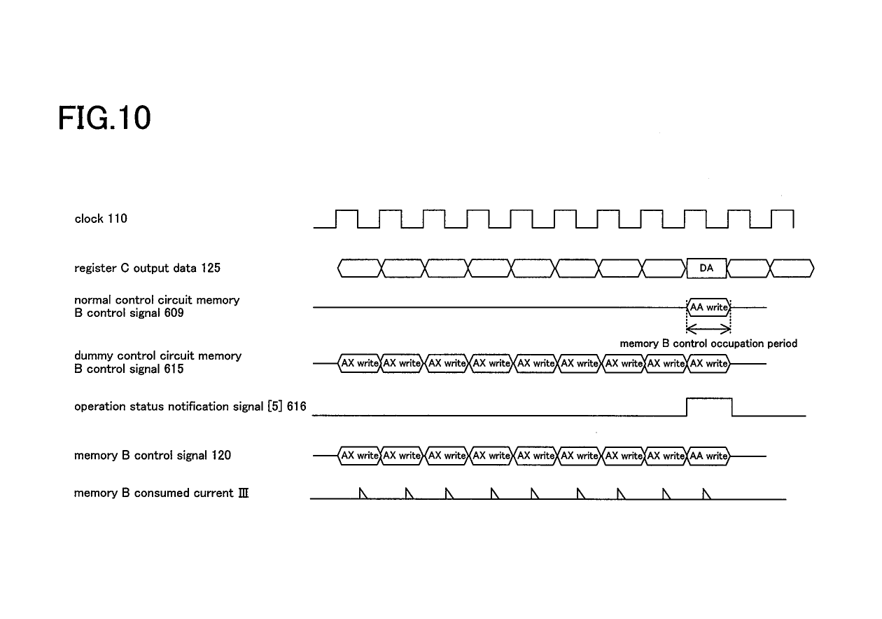

FIG. 10 shows an example in which, based on the operation status notification signal [5] 616 from the operation status notification circuit 600, the memory B control signal 120 is selected from the normal control circuit memory B control signal 609 or the dummy control circuit memory B control signal 615.

The operation status notification signal [5] 616 is such that, as a result of decoding of the cryptographic operation instruction 111, the normal control circuit memory B control signal 609 is selected for one clock cycle, and the dummy control circuit memory B control signal 615 is selected for the other clock cycles. The normal control circuit memory B control signal 609 is a signal for writing the register C output data value DA to address AA of the memory B 104. The dummy control circuit memory B control signal 615 is a signal for writing the register C output data 125 to the fixed address AX of memory B 104 every clock. Regarding the write operation to the memory B 104 in accordance with the dummy control circuit memory B control signal 615, data required for the cryptographic operation instruction 111 or the like is likely to be overwritten at some addresses, and therefore, address AX that is not used by the CPU 109 is used as an address for storing data.

Based on the operation status notification signal [5] 616, the selector 603 outputs the memory B control signal 120 in accordance with which write is performed from the normal control circuit memory B control signal 609 or the dummy control circuit memory B control signal 615 to the memory B 104 every clock cycle. In accordance with the memory B control signal 120, the register C output data 125 is written to the memory B 104, and as a result, a consumed current waveform in which a current is consumed every clock cycle, such as the memory B consumed current III, is obtained.

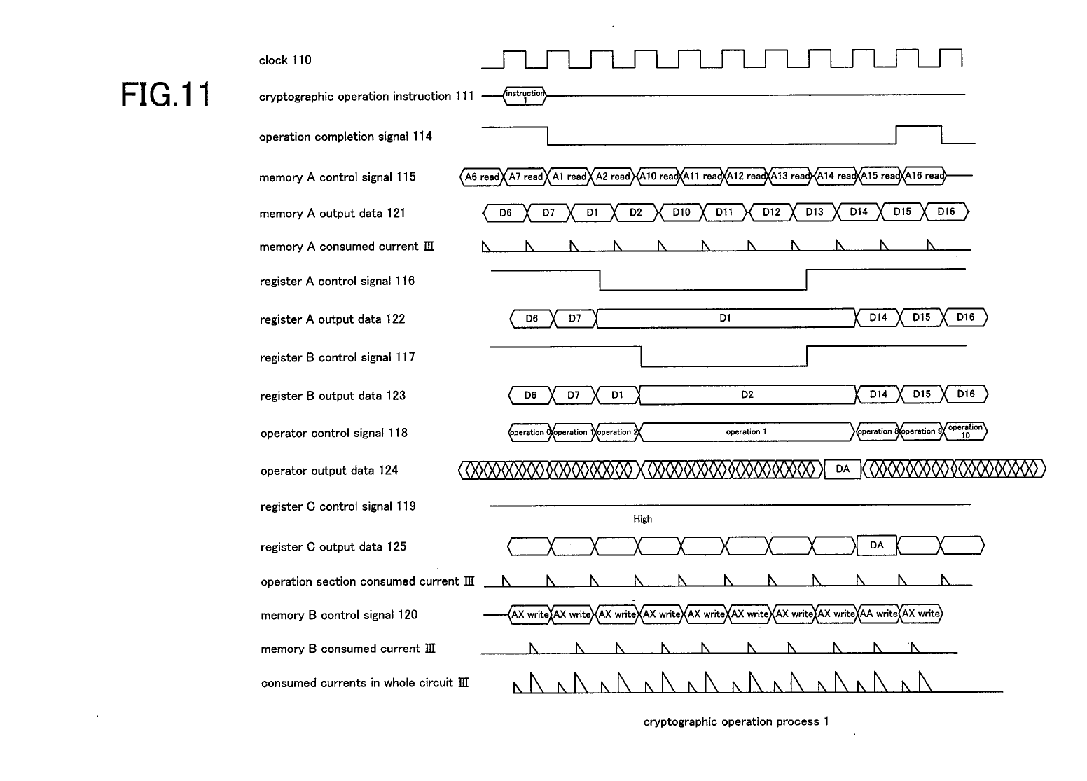

FIG. 11 is a diagram showing FIGS. 7 to 10 together. In FIG. 11, a consumed current waveform in the cryptographic operation processing circuit is an addition of the memory A consumed current III, the operation section consumed current III, and the memory B consumed current III. “Consumed currents III in whole circuit” indicate a total consumed current waveform. The consumed currents III in whole circuit have a more continuous consumed current waveform than that for the “cryptographic operation process 1” period of the consumed currents II in whole circuit of FIG. 2.

Although the operation of the cryptographic control circuit 101 during the execution of the cryptographic operation instruction 111 has been described with reference to FIGS. 7 to 11, the cryptographic control circuit 101 is similarly operated in the case of the dummy operation instruction 113.

As described above, the configuration of FIG. 6 comprises the normal control circuit 601 for generating the normal control signals 604 to 609 for executing the cryptographic operation instruction 111 or the dummy operation instruction 113, the operation status notification circuit 600 for indicating a clock cycle period for which the normal control circuit 601 does not need to occupy the memory A 103, the memory B 104, the operator 105, the register A 106, the register B 107, or the register C 108 even when the cryptographic operation instruction 111 or the dummy operation instruction 113 is being executed, the dummy control circuit 602 for generating the dummy control signals 610 to 615 for forcefully operating the memory A 103, the memory B 104, the operator 105, the register A 106, the register B 107, or the register C 108, and the selector 603 for switching the normal control signals 604 to 609 and the dummy control signals 610 to 615, depending on a notification from the operation status notification circuit 600. Therefore, by switching a control from the normal control circuit 601 to the dummy control circuit 602 for a period of time for which the normal control circuit 601 does not need to occupy the memory A 103, the memory B 104, the operator 105, the register A 106, the register B 107, or the register C 108, the memory A 103, the memory B 104, the operator 105, the register A 106, the register B 107, or the register C 108 can be invariably operated to consume a current, so that a more uniform consumed current is obtained even when the cryptographic operation instruction 111 or the dummy operation instruction 113 is being executed, resulting in a further improvement in security against current analysis.

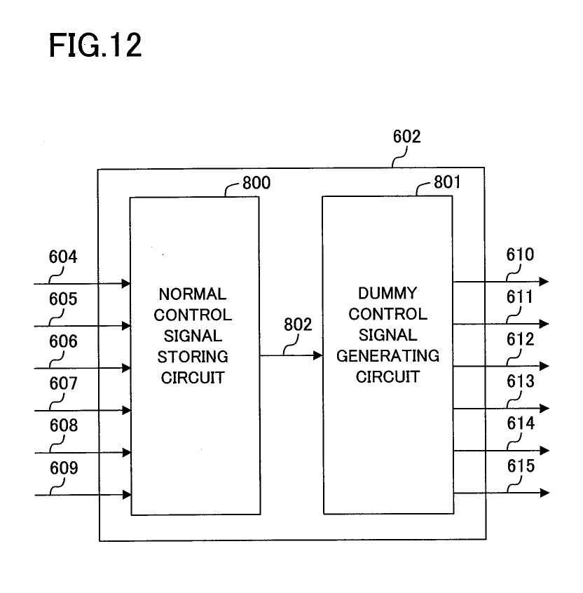

FIG. 12 shows a detailed exemplary configuration of the dummy control circuit 602 of FIG. 6. The dummy control circuit 602 of FIG. 12 comprises a normal control signal storing circuit 800 and a dummy control signal generating circuit 801. The normal control signal storing circuit 800 stores normal control signal history information 802 based on the normal control signals 604 to 609 output by the normal control circuit 601. The dummy control signal generating circuit 801 reads out the normal control signal history information 802 stored in the normal control signal storing circuit 800 and generates and outputs the dummy control signals 610 to 615.

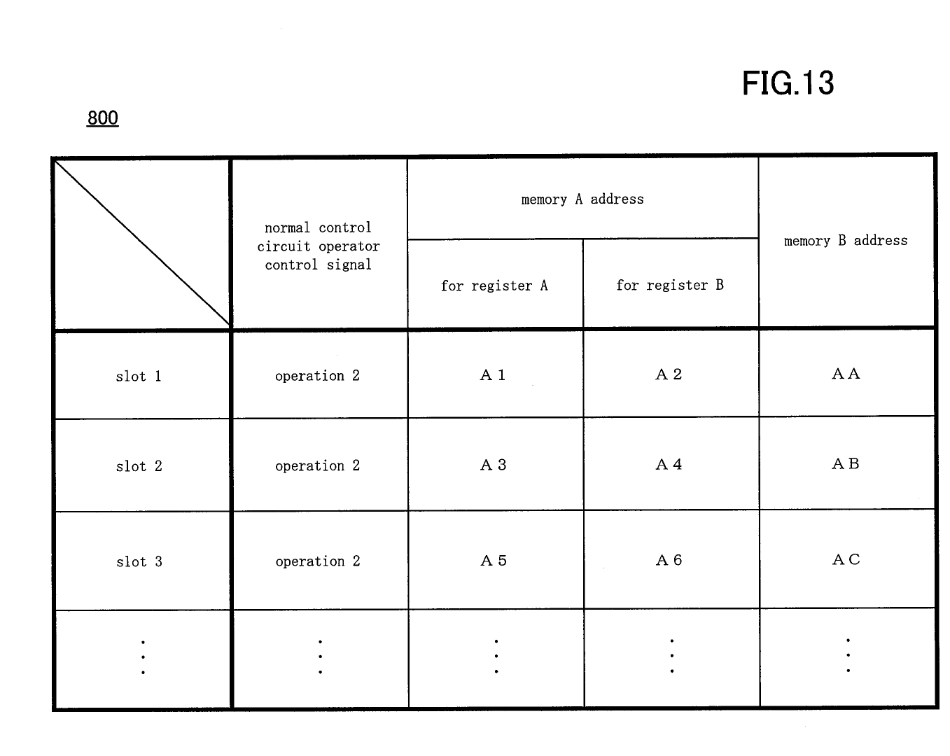

FIG. 13 shows exemplary contents stored in the normal control signal storing circuit 800 of FIG. 12. As shown in FIG. 13, the normal control signal storing circuit 800 comprises a plurality of data storing slots thereinside. Each slot stores a set of the normal control circuit operator control signal 607 output by the normal control circuit 601, a memory A address (for the register A) obtained from the normal control circuit memory A control signal 604 and the normal control circuit register A control signal 605, a memory A address (for the register B) obtained from the normal control circuit memory A control signal 604 and the normal control circuit register B control signal 606, and a memory B address obtained from the normal control circuit memory B control signal 609.

The dummy control signal generating circuit 801 reads out the normal control signal history information 802 stored in these slots and generates the dummy control signals 610 to 615. An algorithm to determine from which slot the dummy control signal generating circuit 801 reads out data may be any of (1) reading out data in order in which the data has been stored, (2) selecting a slot having a most frequent cryptographic operation instruction, (3) randomly selecting a slot, and the like.

When read is performed using an algorithm as described above, operations of the operation resources 103 to 108 performed in the past, operations of the operation resources 103 to 108 having a consumed current waveform having a high frequency of occurrence in the past, and operations of the operation resources 103 to 108 in which past states of a consumed current waveform appear randomly, can be performed even in clock cycle units, so that a consumed current in a cryptographic operation instruction or the dummy operation instruction 113 becomes uniform, resulting in a further improvement in security against current analysis.

Also, the normal control signal storing circuit 800 may be comprised of a non-volatile memory. In this case, past normal control signal history information 802 can be stored after power-off, and the dummy control signals 610 to 615 are selected from the stored normal control signals 604 to 609 and are output. Therefore, even in the case of a current analysis technique in which, for example, a sequence of power-on, execution of a cryptographic operation, and power-off is repeatedly performed to observe changes in current waveform, a consumed current waveform during the execution of the cryptographic operation instruction 111 or the execution of the dummy operation instruction 113 appears, depending on the stored past normal control signals 604 to 609, resulting in a further improvement in security against current analysis.

When the same process is performed in the operator 105, a consumed current in the operator 105 significantly depends on input data to be operated. Specifically, a difference in consumed current occurs between when the input data has a large number of bit values of 0 and when the input data has a small number of bit values of 0. Therefore, in the following example, security against current analysis is improved by using the number of counts of a bit value of 0.

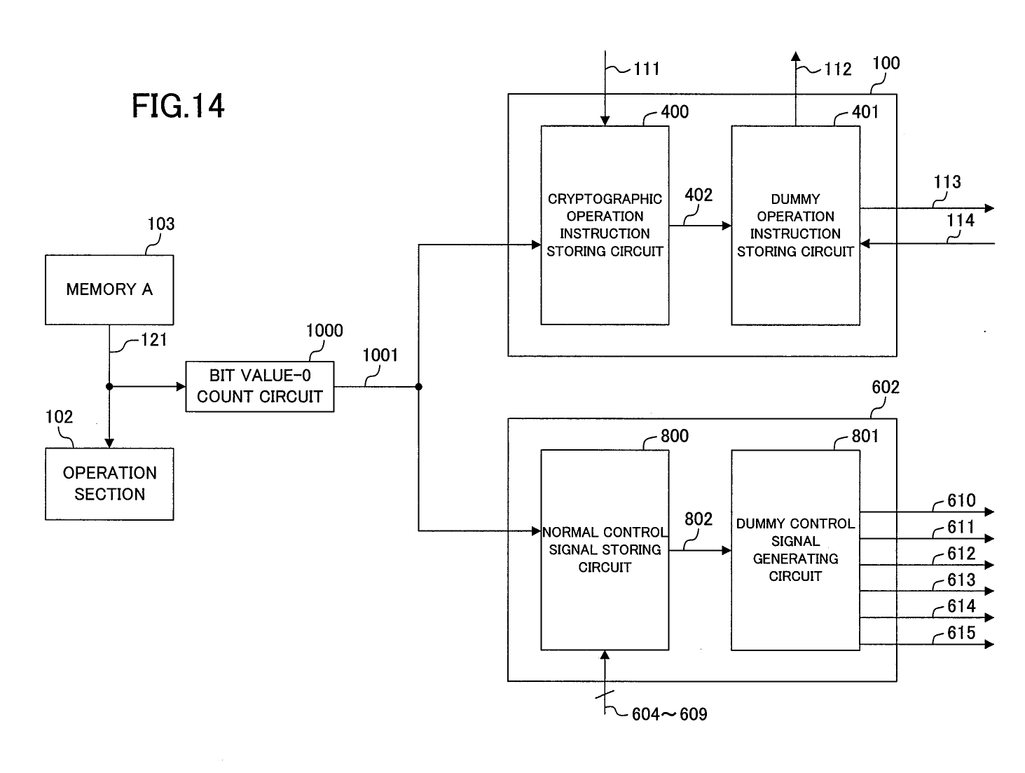

FIG. 14 shows a variation of the cryptographic operation processing circuit of FIG. 1. In FIG. 14, a bit value-0 count circuit 1000 is further provided in addition to the components of the cryptographic operation processing circuit of FIG. 1. The bit value-0 count circuit 1000 receives a value of the memory A output data 121, counts the number of bits having a bit value of 0 in the input data, and outputs the result as bit value-0 count information 1001 to the cryptographic operation instruction storing circuit 400 and the normal control signal storing circuit 800.

For example, if the memory A output data 121 has a data width of 32 bits and outputs data of 39DF7EB6 in hexadecimal, the data is 0011_{—}1001_{—}1101_{—}1111_{—}0111_{—}1110_{—}1011_{—}0110 in binary, so that the number of bits having a bit value of 0 is 10. Therefore, the bit value-0 count information 1001 outputs 10.

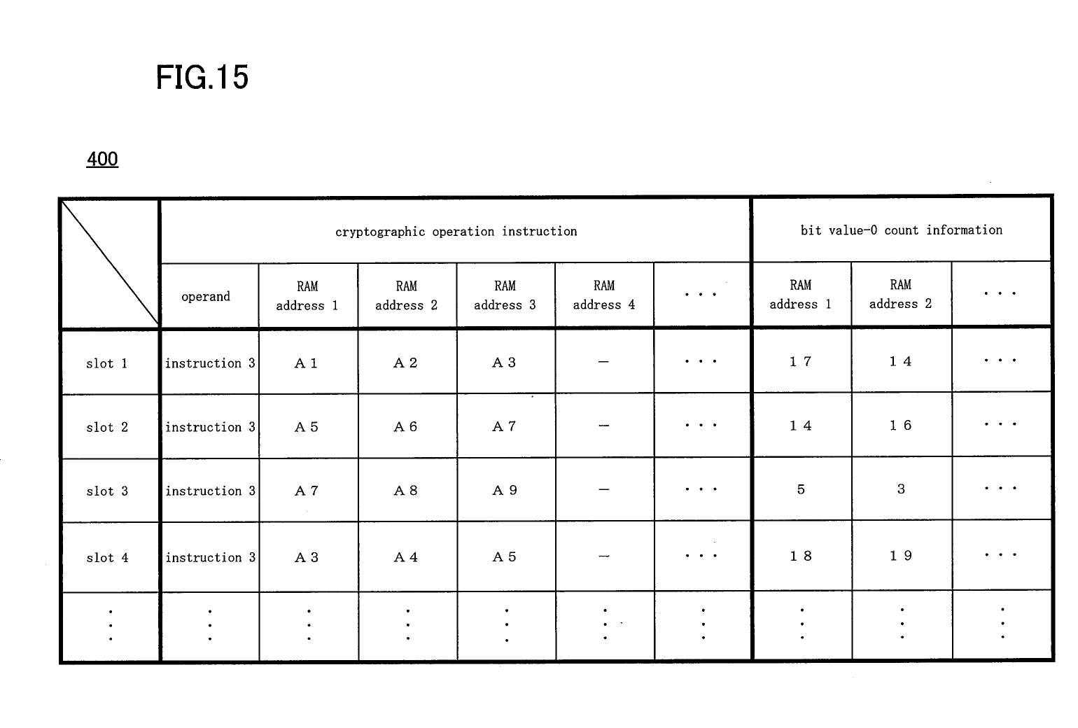

FIG. 15 shows exemplary contents stored in the cryptographic operation instruction storing circuit 400 of FIG. 14. As shown in FIG. 15, the cryptographic operation instruction storing circuit 400 further stores the bit value-0 count information 1001 as well as the cryptographic operation instruction 111 in the same slot. It is here assumed that data stored later is stored in a slot having a smaller slot number.

It is assumed that the memory A output data 121 has a data width of 32 bits. In this case, by the cryptographic operation instruction 111 stored in slot 1 of FIG. 15, an operation of instruction 3 where data at each of address A1 and address A2 is input is performed, and the result is stored at address A3. In this case, the bit value-0 count information 1001 counted by the bit value-0 count circuit 1000 is 17 at address A1 and 14 at address A2.

By the cryptographic operation instruction 111 stored in slot 2, an operation of instruction 3 where data at each of address A5 and address A6 is input is performed, and the result is stored at address A7. In this case, the bit value-0 count information 1001 counted by the bit value-0 count circuit 1000 is 14 at address A5 and 16 at address A6.

By the cryptographic operation instruction 111 stored in slot 3, an operation of instruction 3 where data at each of address A7 and address A8 is input is performed, and the result is stored at address A9. In this case, the bit value-0 count information 1001 counted by the bit value-0 count circuit 1000 is 5 at address A7 and 3 at address A8. In other words, both data read out from address A7 and data read out from address A8 have a small number of counts of a bit value of 0 in the 32-bit data width.

By the cryptographic operation instruction 111 stored in slot 4, an operation of instruction 3 where data at each of address A3 and address A4 is input is performed, and the result is stored at address A5. In this case, the bit value-0 count information 1001 counted by the bit value-0 count circuit 1000 is 18 at address A3 and 19 at address A4.

All the cryptographic operation instructions 111 stored in the slots are an instruction that issues instruction 3 to the operator 105. The number of counts of a value of 0 stored in each slot is small in slot 3 and is similar in slot 1, slot 2, and slot 4. If data having a considerably small or large number of counts of a value of 0 for the data width exists, the number of bits to be activated is considerably small in a cryptographic operation employing such data, so that a characteristic peak occurs in a consumed current waveform during a cryptographic operation process.

The dummy operation instruction generating circuit 401 receives the operation completion signal 114 that is a signal indicating that the execution of the cryptographic operation instruction 111 has been ended, and scans the cryptographic operation instructions 111 stored in slot 1 to slot 4. When recognizing that all the slots have instruction 3, the dummy operation instruction generating circuit 401 further scans the bit value-0 count information 1001. If data having a considerably small or large number of counts of a value of 0 for the data width exists, an operation employing such data has a considerably small number of bits to be activated, so that a characteristic peak occurs in a consumed current waveform during a cryptographic operation process. Therefore, the dummy operation instruction 113 is generated so as to intentionally increase the number of such peaks. Thereby, slot 3 that is a slot having a smallest bit value-0 count number is selected to generate the dummy operation instruction 113.

As described above, in the cryptographic operation processing circuit having the configuration of FIG. 14, the dummy operation instruction generating circuit 401 determines a distribution of bit value-0 count numbers stored in the cryptographic operation instruction storing circuit 400, and selects the cryptographic operation instruction 111 employing a largest or smallest bit value-0 count number to generate the dummy operation instruction 113. Therefore, the generated dummy operation instruction 113 can indicate a specific past consumed current waveform, so that it is difficult to distinguish the execution of a cryptographic operation instruction 111 from the execution of a cryptographic operation instruction 111 indicating a specific past consumed current waveform as the dummy operation instruction 113, resulting in a further improvement in security against current analysis.

Note that the dummy operation instruction generating circuit 401 may determine a distribution of bit value-0 count numbers stored in the cryptographic operation instruction storing circuit 400, and selects a cryptographic operation instruction 111 employing an average bit value-0 count number to generate the dummy operation instruction 113. Since a cryptographic operation instruction 111 employing an average bit value-0 count number is selected to generate the dummy operation instruction 113, the generated dummy operation instruction 113 can indicate an average consumed current waveform, so that it is difficult to distinguish the execution of a cryptographic operation instruction 111 from the execution of a cryptographic operation instruction 111 having a frequent bit value-0 count number in data as the dummy operation instruction 113, resulting in a further improvement in security against current analysis.

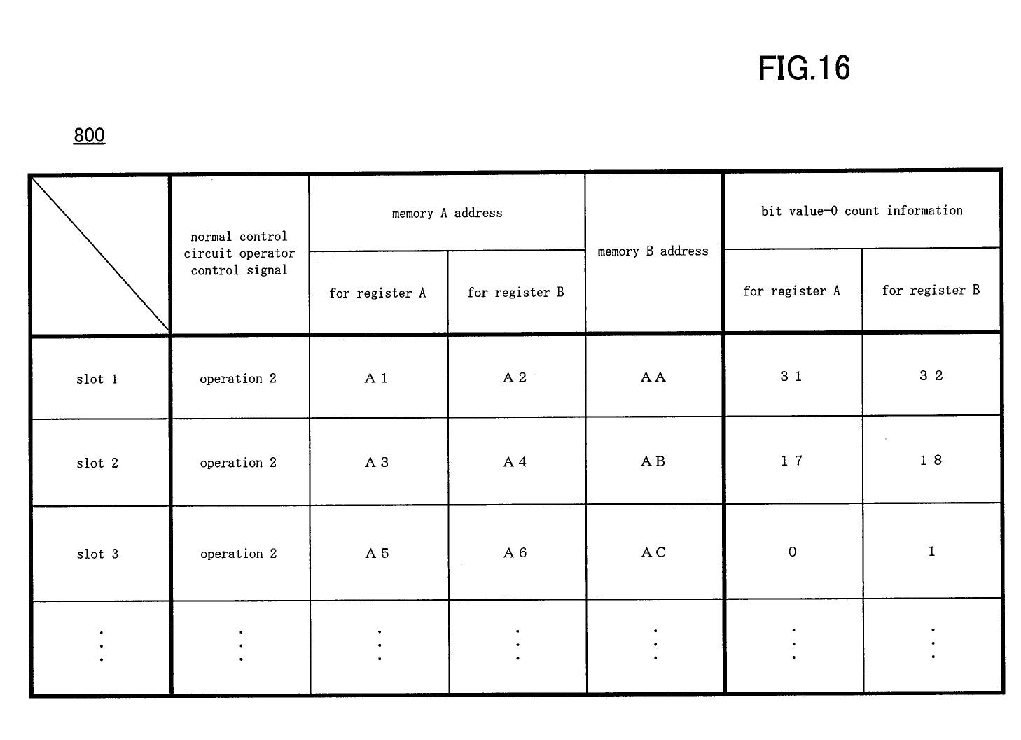

FIG. 16 indicates exemplary contents stored in the normal control signal storing circuit 800 of FIG. 14. As shown in FIG. 16, the normal control signal storing circuit 800 is configured to store a set of the normal control circuit operator control signal 607, the memory A address and the memory B address and, in addition, the bit value-0 count information 1001. It is here assumed that data stored later is stored in a slot having a smaller slot number.

It is assumed that the memory A output data 121 has a data width of 32 bits. According to slot 1 of FIG. 16, operation 2 is issued as the normal control circuit operator control signal 607 with respect to data read out from a memory A address (for the register A) A1 and a memory A address (for the register B) A2, and a result of the operation is written into a memory B address AA. In this case, bit value-0 count information 1001 for the register A and bit value-0 count information 1001 for the register B that are counted by the bit value-0 count circuit 1000 are 31 and 32, respectively. In other words, they are data having a considerably large number of counts of a bit value of 0 for the 32-bit data width.

Also, conversely, in the data stored in slot 3 of FIG. 16, bit value-0 count information 1001 for the register A and bit value-0 count information 1001 for the register B that are counted by the bit value-0 count circuit 1000 are 0 and 1, respectively. They are data having a considerably small number of counts of a bit value of 0 for the 32-bit data width.

As described above, when data having a considerably small or large value-0 count number for the data width exists, a cryptographic operation employing such data has a considerably small number of bits to be activated, so that a characteristic peak occurs in a consumed current waveform during a cryptographic operation process.

Data stored in slot 1 is the latest data, and therefore, the normal control circuit 601 recently outputs the normal control signals 604 to 609 in which a characteristic peak as described above occurs. In such a case, the following dummy control signals 610 to 615 cannot be effectively deceptive unless they are a control signal in which a similar characteristic peak occurs. Also, conversely, when the normal control circuit 601 outputs the normal control signals 604 to 609 in which a characteristic peak as described above does not occur are output, the following dummy control signals 610 to 615 cannot be effectively deceptive unless they are a control signal in which a characteristic peak does not occur. Therefore, the dummy control signal generating circuit 801 determines bit value-0 count information 1001 in slots that have been stored at the latest, and reads out data in a slot having, for example, average, largest or smallest bit value-0 count information 1001 and generates the dummy control signals 610 to 615.

By performing such a dummy operation, it is difficult to distinguish a consumed current waveform during the execution of an original cryptographic operation from that during the dummy operation, so that the timing of the original cryptographic operation is not likely to be analyzed.

As described above, in the cryptographic operation processing circuit having the configuration of FIG. 14, the number of bit values of 0 in the memory A output data 121 is counted by the bit value-0 count circuit 1000, and the count value is stored into the cryptographic operation instruction storing circuit 400 and the normal control signal storing circuit 800, so that a consumed current waveform having the same characteristic as that of a specific consumed current waveform occurring in the past or an average consumed current waveform can be reproduced. Therefore, it is difficult to distinguish a cryptographic operation process from a dummy operation process by consumed current analysis, resulting in an improvement in security against consumed current analysis.

In successive controls of the operator 105, even if values of input data read out from different addresses in the memory A 103 are completely the same, a current is not consumed in the operator 105. Therefore, in the following example, security against current analysis is improved by presetting a potential of a circuit included in the operator 105.

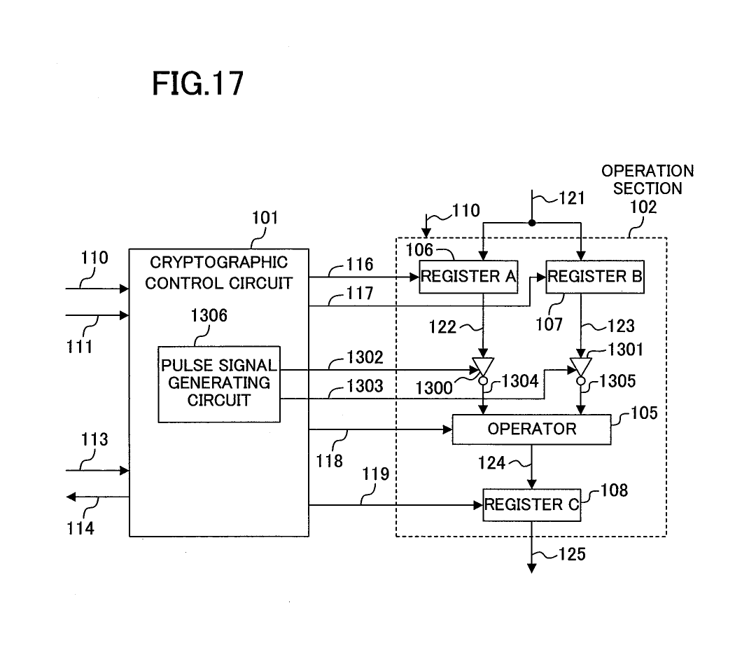

FIG. 17 shows a configuration of the cryptographic control circuit 101 and the operation section 102 according to a variation of FIG. 6. The operation section 102 of FIG. 17 further comprises, in addition to the components of the operation section 102 of FIG. 1, a preset circuit A 1300 and a preset circuit B 1301 so as to preset a potential of a circuit included in the operator 105. In the example of FIG. 17, both the preset circuits 1300 and 1301 are, for example, inverter circuits. Also, the cryptographic control circuit 101 of FIG. 17 further comprises, in addition to the components of the cryptographic control circuit 101 of FIG. 6, a pulse signal generating circuit 1306 for generating a pulse signal synchronous with an operation start clock edge so as to operate both the preset circuits 1300 and 1301.

The preset circuit A 1300, when a preset circuit A control signal 1302 from the pulse signal generating circuit 1306 becomes effective, inverts the register A output data 122 from the register A 106 and outputs the result as preset circuit A output data 1304 to the operator 105.

The preset circuit B 1301, when a preset circuit B control signal 1303 from the pulse signal generating circuit 1306 becomes effective, inverts the register B output data 123 from the register B 107 and outputs the result as a preset circuit B output data 1305 to the operator 105.

The pulse signal generating circuit 1306 is a circuit for generating a pulse signal using the clock 110. The generated signal is output as the preset circuit A control signal 1302 and the preset circuit B control signal 1303 to the preset circuit A 1300 and the preset circuit B 1301.

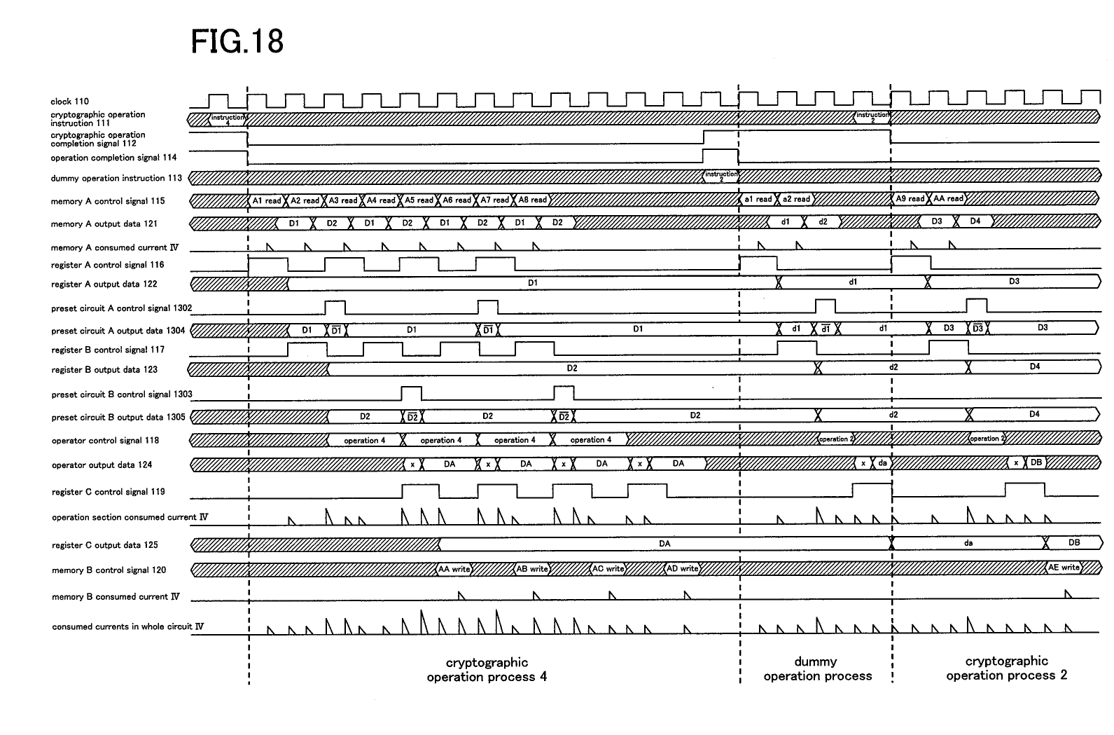

FIG. 18 shows an operation of a cryptographic operation processing circuit comprising the cryptographic control circuit 101 and the operation section 102 of FIG. 17.

In FIG. 18, the cryptographic control circuit 101 receives instruction 4 by the cryptographic operation instruction 111 from the CPU 109. It is here assumed that instruction 4 causes the operator 105 to execute operation 4 of two clock cycles four times in a series of cryptographic operation processes.

The cryptographic control circuit 101 decodes instruction 4, reads out data D1 and data D2 from address A1 to address A8 of the memory A 103, and stores data D1 into the register A 106 and data D2 into the register B 107. A memory A consumed current IV is a consumed current caused by a read operation being performed by the memory A 103, and has a consumed current waveform corresponding to a read operation from address A1 to address A8.

The cryptographic control circuit 101 instructs the operator 105 to execute operation 4 by the operator control signal 118. In this case, the pulse signal generating circuit 1306 controls the preset circuit A control signal 1302 to temporarily invert the register A output data 122 and output the result to the preset circuit A output data 1304. Thereby, the operator 105 temporarily executes an operation of data obtained by inverting D1, and D2 before performing an operation of the original data D1, and D2. An operation section consumed current IV is changed every time data is stored into the register A 106 and the register B 107 that are input registers for the operator 105 (combinational circuit), and even after values in the register A 106 and the register B 107 are settled, an operation is executed and a current is therefore consumed for two clock cycles.

When the memory A output data 121 read out from address A1 to address A8 is a succession of D1 and D2 as shown in FIG. 18, the values in the register A output data 122 and the register B output data 123 are not changed. In such a case, in conventional configurations, the input of the operator 105 is not changed, and the operator 105 is not actually operated, so that a current is not consumed. In the present invention, the preset circuit A 1300 and the preset circuit B 1301 are controlled by the pulse signal generating circuit 1306 so that input data is temporarily inverted, whereby an operation process is executed, so that the operator 105 consumes a current.

Next, the cryptographic control circuit 101 decodes instruction 4 to output the register C control signal 119 for storing an operation result into the register C 108 with timing when operation 4 is ended, so that DA is stored into the register C 108. Also, the cryptographic control circuit 101 decodes instruction 4 to issue the memory B control signal 120, so that DA (register C output data 125) is stored into address AA to address AD of the memory B 104. A memory B consumed current IV is a consumed current caused by a write operation to the memory B 104, and has a consumed current waveform corresponding to a write operation to address AA to address AD.

As described above, with the configuration of FIG. 17, the pulse signal generating circuit 1306 controls the preset circuit A control signal 1302 and the preset circuit B control signal 1303 so that data to be input to the operator 105 is temporarily inverted. Therefore, even if input data to the operator 105 has the same value every clock cycle, a potential inside the operator 105 is forcedly changed every clock edge, so that a current is consumed, resulting in an improvement in security against current analysis.

Although an inverter circuit has been described as an example of the preset circuits 1300 and 1301 of FIG. 17, a circuit that resets each signal in the operation section 102 to a fixed value may be employed.

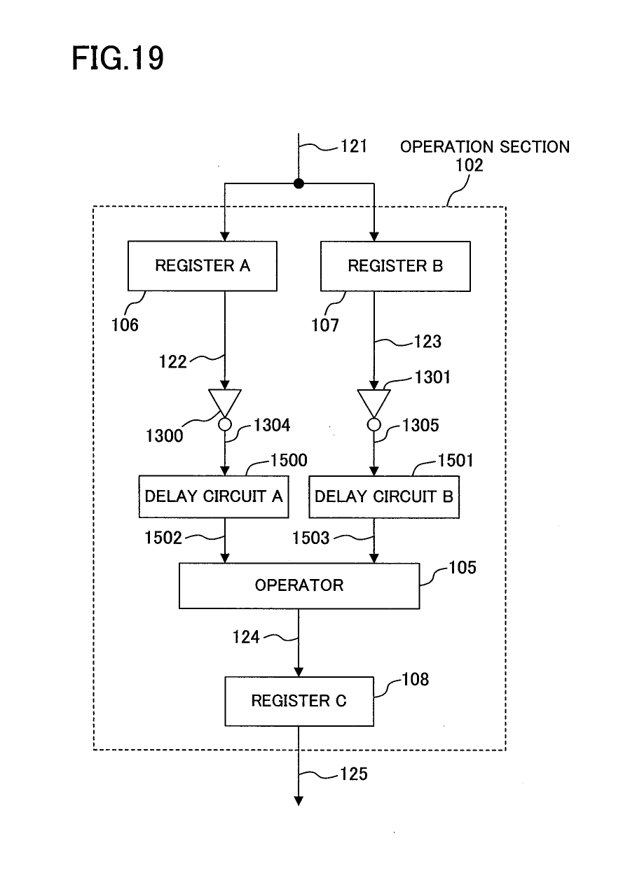

FIG. 19 shows a configuration of an operation section 102 according to a variation of FIG. 17. The operation section 102 of FIG. 19 further comprises, in addition to the components of the operation section 102 of FIG. 17, a delay circuit A 1500 and a delay circuit B 1501 for providing a delay value with respect to each bit of input data to the operator 105, the delay values differing from each other. Note that control signals are not shown in FIG. 19.

The delay circuit A 1500 adds a delay amount to each bit of the preset circuit A output data 1304 from the preset circuit A 1300 every clock cycle, the delay amounts differing from each other, and outputs the resultant data in which not all the bits are changed with the same timing, as delay circuit A output data 1502, to the operator 105.

The delay circuit B 1501 adds a delay amount to each bit of the preset circuit B output data 1305 from the preset circuit B 1301, the delay amounts differing from each other, and outputs the resultant data in which not all the bits are changed with the same timing, as delay circuit B output data 1503, to the operator 105.

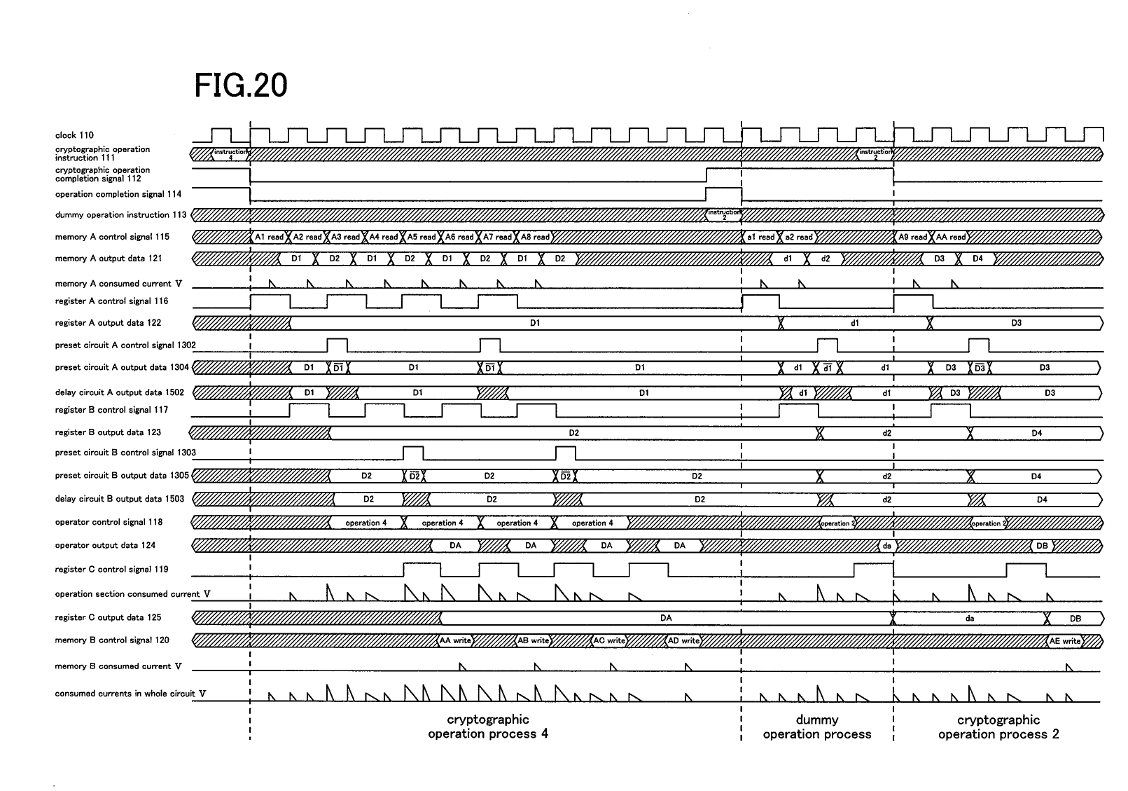

FIG. 20 shows an operation of a cryptographic operation processing circuit comprising the operation section 102 of FIG. 19. In FIG. 20, the cryptographic control circuit 101 receives instruction 4 by the cryptographic operation instruction 111 from the CPU 109. It is here assumed that instruction 4 causes the operator 105 to execute operation 4 of two clock cycles four times in a series of cryptographic operation processes.

The cryptographic control circuit 101 decodes instruction 4, reads out data D1 and data D2 from address A1 to address A8 of the memory A 103, and stores data D1 into the register A 106 and data D2 into the register B 107. A memory A consumed current V is a consumed current caused by a read operation being performed by the memory A 103, and has a consumed current waveform corresponding to a read operation from address A1 to address A8.

The cryptographic control circuit 101 instructs the operator 105 to execute operation 4 by the operator control signal 118. In this case, the pulse signal generating circuit 1306 controls the preset circuit A control signal 1302 to temporarily invert the register A output data 122 and output the result to the preset circuit A output data 1304. Further, the delay circuit A 1500 adds a delay amount to each bit of the preset circuit A output data 1304 every clock cycle, the delay amounts differing from each other, and outputs the resultant data in which not all the bits are changed with the same timing, as delay circuit A output data 1502. Thereby, the operator 105 temporarily executes an operation of data obtained by inverting D1, and D2 before performing an operation of the original data D1, and D2. In addition, since the delay amount is changed every bit at a change point of data, the operator 105 executes an operation with respect to continuously differing data. An operation section consumed current V is changed every time data is stored into the register A 106 and the register B 107 that are input registers for the operator 105 (combinational circuit), and even after values in the register A 106 and the register B 107 are settled, an operation is executed and a current is therefore consumed for two clock cycles.

When the memory A output data 121 read out from address A1 to address A8 is a succession of D1 and D2 as shown in FIG. 20, the values in the register A output data 122 and register B output data 123 are not changed. In such a case, in conventional configurations, the input of the operator 105 is not changed, and the operator 105 is not actually operated, so that a current is not consumed. In the present invention, the preset circuit A 1300 and the preset circuit B 1301 are controlled by the pulse signal generating circuit 1306 so that input data is temporarily inverted, and further, a delay amount is added to each bit of the input data every clock cycle by the delay circuit A 1500 and the delay circuit B 1501, the delay amounts differing from each other, thereby continuously changing the input data, so that the operator 105 can continuously execute an operation.

Next, the cryptographic control circuit 101 decodes instruction 4 to output the register C control signal 119 for storing an operation result into the register C 108 with timing when operation 4 is ended, so that DA is stored into the register C 108. Also, the cryptographic control circuit 101 decodes instruction 4 to issue the memory B control signal 120, so that DA (register C output data 125) is stored into address AA to address AD of the memory B 104. A memory B consumed current V is a consumed current caused by a write operation to the memory B 104, and has a consumed current waveform corresponding to a write operation to address AA to address AD.

As described above, with the configuration of FIG. 19, the pulse signal generating circuit 1306 controls the preset circuit A control signal 1302 and the preset circuit B control signal 1303 so that data to be input to the operator 105 is temporarily inverted, and further, a delay amount is added to each bit of data to be input to the operator 105 every clock cycle by the delay circuit A 1500 and the delay circuit B 1501, the delay amounts differing from each other. Thereby, a consumed current waveform in the operator 105 is affected by the delay of the input data, resulting in an improvement in security against consumed current analysis.

### INDUSTRIAL APPLICABILITY

As described above, the cryptographic operation processing circuit of the present invention is useful as a data processing circuit for which security, such as a cryptographic operation or the like, is required, and is applicable to IC cards and the like.

1. (canceled)

2. (canceled)

3. A cryptographic operation processing circuit comprising:
a memory for storing data for a cryptographic operation;
an operator for operating the cryptographic operation data;
a register for temporarily storing input/output data of the operator;
a cryptographic control circuit for receiving a cryptographic operation instruction and controlling the memory, the operator and the register so as to perform a cryptographic process with respect to the cryptographic operation data; and
a dummy operation instruction circuit for receiving an operation completion signal indicating that execution of the cryptographic operation instruction has been ended, and issuing a dummy operation instruction for operating the memory the operator and the register to the cryptographic control circuit,
wherein the dummy operation instruction circuit includes:
a cryptographic operation instruction storing circuit for storing the cryptographic operation instruction; and
a dummy operation instruction generating circuit for generating the dummy operation instruction from a past cryptographic operation instruction history.

4. The cryptographic operation processing circuit of claim 3, wherein
the dummy operation instruction generating circuit selects a cryptographic operation instruction having a high frequency of occurrence from the cryptographic operation instruction history stored in the cryptographic operation instruction storing circuit to generate the dummy operation instruction.

5. The cryptographic operation processing circuit of claim 3, wherein
the dummy operation instruction generating circuit randomly selects a cryptographic operation instruction from the cryptographic operation instruction history stored in the cryptographic operation instruction storing circuit to generate the dummy operation instruction.

6. The cryptographic operation processing circuit of claim 3, wherein
the cryptographic operation instruction storing circuit includes a non-volatile memory, and holds a past cryptographic operation instruction history after power-off to generate the dummy operation instruction.

7. The cryptographic operation processing circuit of claim 3, wherein
the cryptographic control circuit includes:
a normal control circuit for generating a normal control signal for executing the cryptographic operation instruction or the dummy operation instruction;
an operation status notification circuit for indicating a period of time for which the normal control circuit does not need to occupy the memory, the operator or the register even when the cryptographic operation instruction or the dummy operation instruction is being executed;
a dummy control circuit for generating a dummy control signal for forcefully operating the memory, the operator or the register for a period of time for which the memory, the operator and the register are inactivated; and
a selector for switching the normal control signal and the dummy control signal, depending on a notification from the operation status notification circuit.

8. The cryptographic operation processing circuit of claim 7, wherein
the dummy control circuit includes:
a normal control signal storing circuit for storing an address of the memory output by the normal control circuit, and an operator control signal for controlling the operator; and
a dummy control signal generating circuit for generating the dummy control signal from a past normal control signal history.

9. The cryptographic operation processing circuit of claim 8, wherein
the dummy control signal generating circuit selects a normal control signal having a high frequency of occurrence from a normal control signal history stored in the normal control signal storing circuit to generate the dummy control signal.

10. The cryptographic operation processing circuit of claim 8, wherein
the dummy control signal generating circuit randomly selects a normal control signal from a normal control signal history stored in the normal control signal storing circuit to generate the dummy control signal.

11. The cryptographic operation processing circuit of claim 8, wherein
the normal control signal storing circuit includes a non-volatile memory, and holds a past normal control signal history after power-off to generate the dummy control signal.

12. The cryptographic operation processing circuit of claim 8, further comprising:
a bit value-0 count circuit for counting the number of bit values of 0 included in data read out from the memory,
wherein the cryptographic operation instruction storing circuit further has a function of storing a bit value-0 count number from the bit value-0 count circuit.

13. The cryptographic operation processing circuit of claim 12, wherein
the dummy operation instruction generating circuit determines a distribution of bit value-0 count numbers stored in the cryptographic operation instruction storing circuit, and selects a cryptographic operation instruction employing an average bit value-0 count number to generate the dummy operation instruction.

14. The cryptographic operation processing circuit of claim 12, wherein
the dummy operation instruction generating circuit determines a distribution of bit value-0 count numbers stored in the cryptographic operation instruction storing circuit, and selects a cryptographic operation instruction employing a largest or smallest bit value-0 count number to generate the dummy operation instruction.

15. The cryptographic operation processing circuit of claim 12, wherein
the normal control signal storing circuit further has a function of storing a bit value-0 count number from the bit value-0 count circuit.

16. The cryptographic operation processing circuit of claim 15, wherein
the dummy control signal generating circuit determines a distribution of bit value-0 count numbers stored in the normal control signal storing circuit, and selects a normal control signal employing an average bit value-0 count number to generate the dummy control signal.

17. The cryptographic operation processing circuit of claim 15, wherein
the dummy control signal generating circuit determines a distribution of bit value-0 count numbers stored in the normal control signal storing circuit, and selects a normal control signal employing a largest or smallest bit value-0 count number to generate the dummy control signal.

18. The cryptographic operation processing circuit of claim 7, further comprising:
a preset circuit for presetting a potential of a circuit included in the operator,
wherein the cryptographic control circuit further includes a pulse signal generating circuit for generating a pulse signal synchronous with an operation start clock edge of the operator to operate the preset circuit.

19. The cryptographic operation processing circuit of claim 18, wherein
the preset circuit inverts output data of the register only for a period of time of the pulse signal of the pulse signal generating circuit.

20. The cryptographic operation processing circuit of claim 18, further comprising:
a delay circuit for providing a delay value for each bit of input data to the operator, the delay values differing from each other.
